(19) United States
(12) Patent Application Publication
(10) Pub. No.: US 2002/0079208 A1
(43) Pub. Date: Jun. 27, 2002

(54) Electrical switching device having illuminating means

(76) Inventors: Urs Campana, Zwingen (CH); Dieter Rammelmeyer, Reinach (CH)

Correspondence Address: COLLEN LAW ASSOCIATES, P.C, Counselor at Law, The Holyoke-Manhattan Building, 80 South Highland Avenue, Ossining, NY, 10562, US

(21) Appl. No.: 10/003,995

(22) Filed: Nov. 15, 2001

(30) Foreign Application Priority Data
Nov. 17, 2000 (CH) 2000 2249/00

(51) Int. Cl. H01H 9/00

(52) U.S. Cl. 200/310

(57) ABSTRACT

The electrical switching device (1) has a housing (3) which can be fastened on a support (2), an actuator (8) having a pressing surface and illuminating means for visualization of the pressing surface. A disc-like cover plate (6) which has a contact surface (6b) for a piezoelectric switching element (12) provided in the housing is arranged on the front of the housing (3). Said switching element is arranged in such a way that an electrical signal is generated on pressing the actuator (8) in contact with the cover plate (6). According to the invention, the cover plate (6) is at least partly transparent and is provided, on its underside, facing the interior of the housing (3), with several light emitting diodes (16) distributed regularly over a circle and intended for radiating light out of the cover plate (6).

### DESCRIPTION

The invention relates to an electrical switching device having illuminating means according to the precharacterizing clause of claim 1.

The switching device is provided in particular with a housing intended for fastening to a support, an actuator intended for pressing and illuminating means for visualization of the pressing surface of the actuator and/or for indication of the switching state, the housing having an electromechanical switching element intended for triggering a switching state, for example a switching element as used in known mechanical toggle, rotary and pressure switches, or electronic switching element, for example a piezoelectric switching element.

An electronic switching device according to the invention is equipped, for example, with a noticeable stroke and a piezoelectric switching element. Such a switching device, also referred to below as switch, combines the advantages of electronic switches, such as high reliability of switching and lack of mechanical wear, with those of an electrical switch, which converts a noticeable mechanical movement directly into a switching pulse. Known switches of this type have an actuator, which is displaceable between two end positions against the force of a spring, and a contact-sensitive sensor, which, for example, converts a mechanical deformation of a membrane, triggered by the actuator, into an electrical signal.

Switching devices having illuminating means are intended for the visualization of a switching state or for applications in which they are fastened to a plate like support and can be actuated by pressing from the surrounding space adjacent to the front of the support, even if said space is dark, i.e. for example during the night.

European Patent 0 417 048 and German Utility Model 297 12 888 disclose such switching devices. These have a housing intended for fastening to a support, an actuator intended for pressing and illuminating means for indicating a switching state, the housing having, on the front, a disc-like cover plate facing the actuator, and an electromechanical or electronic switching element for triggering the switching state being arranged on that side of the cover plate which is opposite the actuator. Switching devices of this known design have the disadvantage that the illuminating means are not provided for illuminating the whole of the actuator, reveal only its edge region all around on illumination and that the dimensions and measurements of the actuator therefore cannot be freely chosen and are limited by the design of the cover plate and the arrangement of the illuminating means.

It is the object of the invention to provide a switching device of the type stated at the outset which does not have these known disadvantages and can be produced in a relatively economical manner and in which the parts required for changing the switching state and the illuminating means are sealed liquid-tight or even gas-tight from the environment. The device should furthermore be formed in such a way that it can withstand even high stresses and relatively large forces and environmental effects applied to the switching device from said surrounding space.

This object is achieved by a switching device which has, according to the invention, the features of claim 1.

Advantageous embodiments of the switching device are evident from the dependent Claims.

When they are of suitable dimensions, switching devices of the type according to the invention are robust and resistant to vibration and to shocks, impacts and other mechanical forces and violent actions applied to them. Since in addition all switch parts carrying electrical voltages are arranged on that side of the cover plate of the housing which faces away from the actuator, these parts can readily be sealed liquid-tight and even gas-tight from the environment.

Switching devices according to the invention can therefore be mounted on vehicles of all kinds, for example on the outer wall of railway cars or tram cars or buses or trolley buses and serve for opening the doors. Furthermore, the switching devices can also be fastened to doors or to movable parts of machines or the like. Moreover, automatic machines for dispensing tickets or beverages or solid foods or other objects can be provided with such switching devices. Furthermore, such switching devices can be mounted on building walls and serve, for example, for switching on the light or, in entrances to lifts, for fetching the lift, or, with a flat design, the switching devices may be suitable for being used in window glass or sheet metal where they can be operated from both sides.

Switching devices according to the invention are also advantageous for purposes where high atmospheric humidity is present in the environment or where apparatuses provided with switching devices should be capable of being cleaned with water or a steam jet or water or another liquid can otherwise can come into contact with the switching devices.

The housing is preferably formed in such a way that it can be detachably fastened by fastening means to a usually plate-like support and is present partly on the front thereof, so that a person can press the pressing surface manually—i.e. with a finger—from the surrounding space adjacent to the front. In a preferred embodiment of the subject of the invention, at least those sections of the housing wall which are accessible from said surrounding space consist of a metallic material, for example stainless steel or aluminium, or of plastic. A partly or completely metallic housing is particularly resistant to shocks, impacts and other large, external mechanical forces and violent actions. For special cases where an electrically insulating housing is desired, for example for safety reasons, the switching device can however also be provided with a housing which consists of an electrically insulating, possibly glass fibre-reinforced, plastic.

In a particularly preferred embodiment of the invention, the actuator has a relatively large area and is readily visible to ensure suitability for disabled persons, in such a way that it can be actuated over its entire surface and in particular by means of the ball of the thumb, an elbow, etc. For this purpose, the switching device is provided with a spring element which is arranged between the actuator and the cover plate and centralizes the pressure in the direction of the contact surface.

The subject of the invention is explained with reference to two embodiments shown in the drawing. In the drawing,

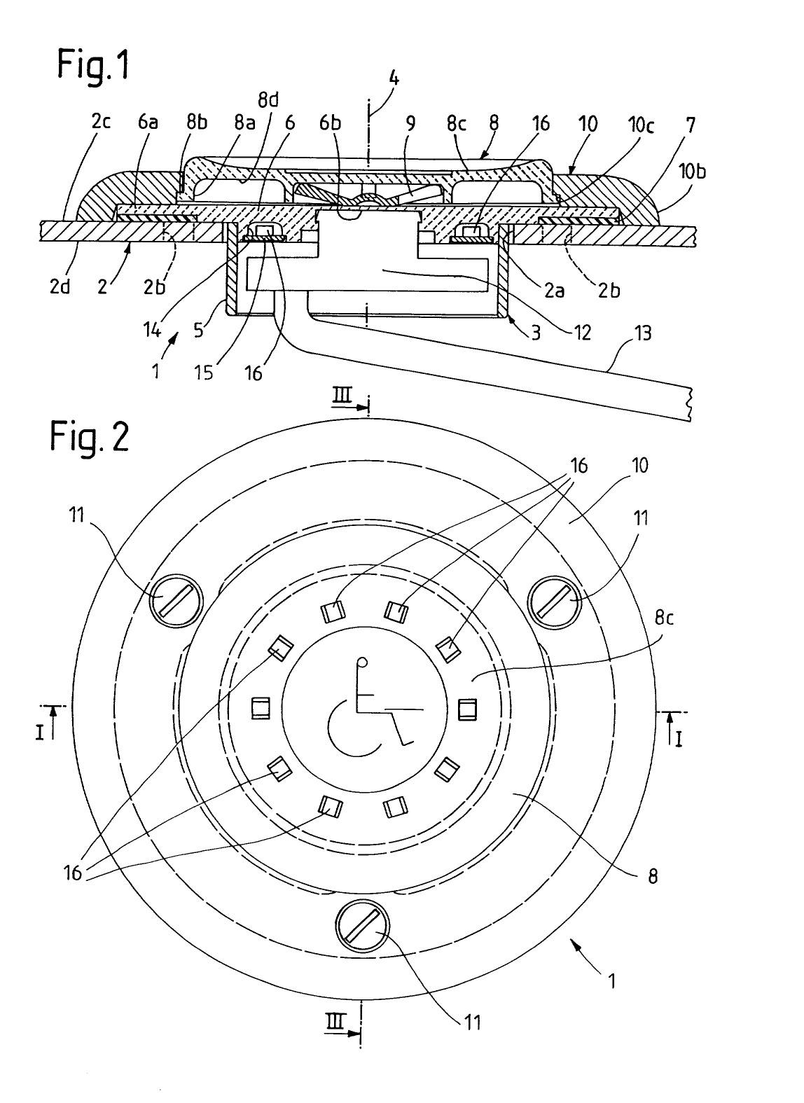

FIG. 1 shows a section along the line I-I of

FIG. 2, which in turn is a plan view of a first variant of the switching device,

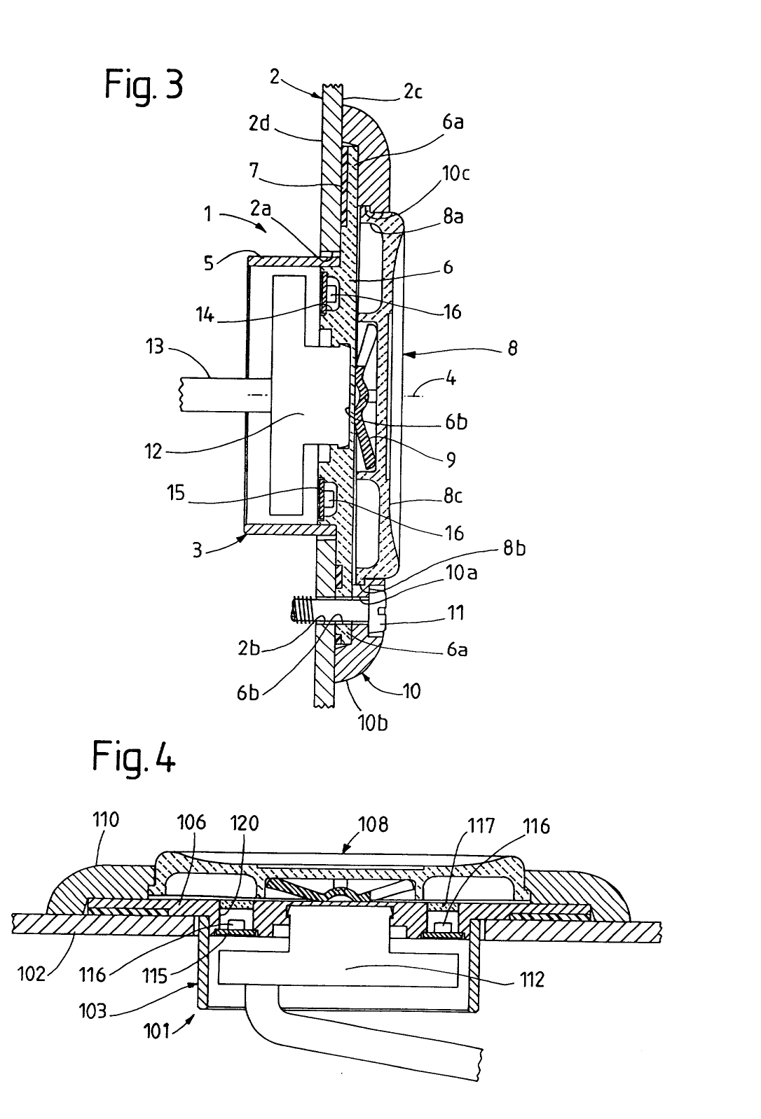

FIG. 3 shows a section along the line III-III of FIG. 2,

FIG. 4 shows a section through a second variant of a switching device which differs in the type of illuminating means from the switching device shown in FIGS. 1 to 3, and

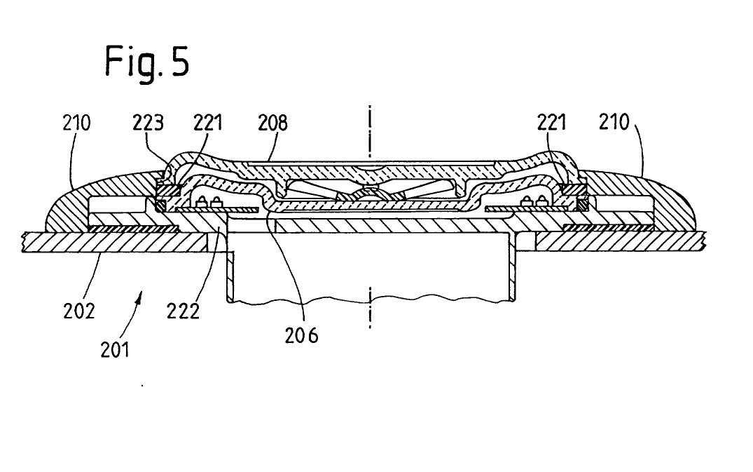

FIG. 5 shows a section through a third variant of a switching device.

The electrical switching device shown in FIGS. 1 to 3, denoted as a whole by 1 and intended for controlling and/or switching at least one electrically controllable and/or switchable means is detachably fastened to a nondeformable support 2, of which the part shown in the drawing is preferably plate-like. The support 2 may form, for example, a part of the outer wall of a car or vehicle serving for public transport, such as a railway car or tram car or a bus. The support 2 can, however, also belong to the wall of a building or to a switch board or the like. The support 2 has a circular through-hole 2a and through-holes 2b distributed around said hole 2a and intended for fastening. Said support has a front 2c and a back 2d. The front 2c is adjacent to a surrounding space accessible to persons, while the back 2d is usually inaccessible, i.e. during the normal use of the means.

The switching device 1 has a housing 3 with an axis 4 which is identical to that of the hole 2a. The housing 3 has a cylindrical wall part 5 which consists, for example, of a metallic material, for example stainless steel or aluminium, and is present behind the plane defined by the support front 2c, passes through the hole 2a and projects from this at the back of the support 2d. At the front, the housing 3 has a disc-like, one-part cover plate 6 which is formed at least partly from transparent plastic and forms a support section 6a projecting away from the axis 4 over the cylindrical wall part 5 and rests on the front 2c of the support 2, an annular flat seal 7 or at least an O-ring additionally being provided between the support 2 and the support section 6a, which seal or O-ring extending over at least a part of the width of the support section 6a and preferably fitting in a recess of the support section 6a, which recess is at the edge and faces the front 2c.

An actuator 8 forms the front of the switch 1. In the embodiment shown, it has the form of a round cap with a cylindrical base 8a facing the cover plate 6 of the housing 3 and can be displaced in the direction perpendicular to the contact surface 6b of the cover plate 6 against the force of a spring 9. The actuator 8 preferably consists of plastic or metal and is at least partly transparent.

The actuator 8 fits into an annular metal or plastic anchor plate 10 which likewise has a circular contour and is provided with three holes 10a, each of which is aligned with one of the holes 2b and a through-hole in the cover plate 6. The anchor plate 10 is slightly extended on the outside and rests with the annular extension 10b on the front 2c of the support 2. It is furthermore provided, on its inside, with an annular locking groove 10c which, together with the annular locking rib 8b of the actuator 8, forms fastening and locking means. Furthermore, the top of the cover plate 6 may additionally be adhesively bonded in the region of the support sections 6a to the inner surface of the anchor plate 10 by a thin adhesive layer.

The switch 1 is detachably fastened to the support 2 by means of three screws 11. It should be mentioned here that the screws 11 may also be fastened by means of nuts and, instead of being in the form of countersunk screws, may be in the form of screws having other types of heads, for example intrusion-proof heads, or if necessary may be replaced by concealed pressed-in or welded-in bolts.

The front face of the actuator 8 is provided in its central region with a depression 8c which serves in particular as a finger guide for the operator and is optionally additionally provided with a labelling disc. Instead of using a separate labelling disc, it is of course also possible to label the front face of the actuator 8 in a corresponding manner and if necessary also to colour it.

A piezoelectric switching element 12 comprising a small disc of piezoelectric material and corresponding contacts is arranged in the interior of the housing 3 in a known manner. Thus, the switching element 12 rests, for example with one side of the small disc, against the inside of the contact surface 6b and is if necessary adhesively bonded to said surface. Furthermore, electronic switching means which comprise at least one cable 13 having a group of conductors and leading out of the interior of the housing 3 are arranged in the housing 3.

According to the invention, an annular groove 14 which has, in the base section, an annular light emitting diode holder 15 which consists of an electrically insulating plastic is provided on the underside of the cover plate 6. Several, for example ten, light emitting diodes 16 distributed uniformly along the circumference of the annular groove 14 are fastened to the light emitting diode holder 15.

The annular light emitting diode holder 15 is fastened in the annular groove 14, for example, by pressing in and/or snapping in and/or adhesive bonding. As already mentioned above, the cover plate 6 is at least partly transparent and serves as a light diffuser in order to distribute the light produced during operation of the light emitting diodes 16 and radiated through it at least along the annular groove 14 and, for example, as far as possible uniformly over the entire mouth of the annular groove 14 to the outer circular ring 8d of the actuator 8.

The cover plate 6 consists, at least in the region of the light emitting diodes 16, of a transparent plastic, such as acrylic glass or—more precisely—polymethyl methacrylate or polycarbonate, but could also consist of a mineral glass. The cover plate 6 may additionally have, in the region of the light emitting diode 16, structuring and/or roughening formed by a multiplicity of fine indentations and protuberances, for example radial grooves and ribs, respectively. Such surface structuring results in a large number of small inclined refraction surfaces which deflect and distribute the light striking them by refraction and possibly also by scattering. The cover plate 6 may, however, also be designed in such a way that the light radiated through it is focused or scattered, in which case the surface of the cover plate 6 is not flat but convex or concave.

If a person presses the pressing surface of the actuator 8 with a finger from the surrounding space adjacent to the front 2c of the support, this pressure is transmitted in a known manner to the piezoelectric switching element 12. This then produces an electrical signal which is fed to the electronic switching means.

The switching means arranged in the housing 3 can, for example, switch on and/or switch off and/or switch at least one electrically switchable and/or controllable apparatus—for example a door opening apparatus or a lighting apparatus. When the switching device 1 is used, the switching means usually supply an electrical voltage to at least some of the light emitting diodes 16 so that these light emitting diodes light up. The light emitting diodes 16 produce in particular a more or less uniform light ring which encloses the pressing surface of the actuator 8, indicates the position of the pressing surface also in an otherwise dark surrounding space and makes said position visually detectable and/or indicates the switching state.

The light emitting diodes 16 may all be identically formed and supplied with electric current in such a way that they continuously produce identically coloured light independently of the switching state of the switching device. However, the light emitting diodes 16 can instead be divided into, for example, at least two different light emitting diode groups which are formed for producing light of different colours. Thus, for example, a light emitting diode producing green light and one producing red light can follow one another alternately along the annular groove 14. The switching means can then be formed in such a way that they visualize two different switching states through light of different colours.

The switching means may furthermore be formed in order to cause the light emitting diodes 16 or at least one of them to light up with at least two types of light which have different behaviours as a function of time. It is possible, for example, to ensure that light of one or the other colour is produced continuously in the ready state and in the switched-on state. Any fault state, i.e. the occurrence of an operating fault, or any third switching state can then be indicated, for example, in a manner such that the switching means cause at least some of the light emitting diodes 16 to light up intermittently and periodically so that light blinks or light flashes thus occur.

The electrical switching device shown in FIG. 4 and denoted as a whole by 101 likewise serves for controlling and/or switching an electronically controllable and/or switchable means. It is fastened on an at least partly plate-like support 102 and—like the device 1 of FIGS. 1 to 3—has a housing 103 with a piezoelectric switching element 112 and a cover plate 106, and an anchor plate 110 for fastening and holding the cover plate 106 and the actuator 108 arranged thereon.

In contrast to the embodiment described above, the cover plate 106 in this case is formed from an opaque, resistant, metallic material. Furthermore, the cover plate 106 has an annular gap 120 or at least through-holes distributed regularly over a circle, in which annular gap or through-holes light emitting diodes 116 are arranged on an electrically insulating light emitting diode holder 115.

The annular gap 120 is closed at the front face by a transparent closing means 117. This is present at least partly and in fact completely between the light emitting diodes 116 and the mouth of the annular groove 120. The closing means 117 preferably consists of at least one transparent ring which is fastened in the annular groove by pressing in and/or snapping in and/or adhesive bonding.

The closing means 117 serves for distributing the light produced during operation of the light emitting diodes 116 at least partly along the annular gap 120 and, for example as far as possible uniformly over the entire mouth of the annular gap 120. Said closing means consist, for example, of a transparent plastic, such as acrylic glass or polycarbonate, but could also consist of a mineral glass. The closing means 117 can likewise have structuring and/or roughening formed by a multiplicity of fine indentations and protuberances, for example radial grooves and ribs, respectively, in order thus to deflect and to distribute the light of the light emitting diode 116 by scattering. Such surface structuring can be generated, for example, by producing the ring forming the closing means 117 by injection moulding or pressureless casting and/or compression moulding of flowable material with the aid of a mould having corresponding structuring. The ring can, however, also consist of a translucent material which has a matrix in which pigment particles or pores or pigment particles and pores are distributed.

The electrical switching device shown in FIG. 5 and denoted as a whole by 201 is likewise fastened on an at least partly plate-like support 202. It has, like the devices 1 and 101—a piezoelectric switching element which is not shown in this case and a cover plate 206, and an anchor plate 210 for fastening and holding the cover plate 206 and the actuator 208 arranged thereon. As in the case of the device according to FIG. 1, the cover plate 206 is formed from a transparent, resistant, metallic material.

In contrast to the two embodiments described above, both the cover plate 206 and the actuator 208 have an annular edge section curved outwards at the edge, and a sealing ring 221 made of plastic is additionally present between the two edge sections of the actuator 208 and cover plate 206. Furthermore, said edge sections are snapped into a groove 223 formed from the anchor plate 210 and the housing flange 222.

It should finally be pointed out that the embodiments of switching devices described above can be modified in various ways within the scope of the invention. Thus, for example, it is possible to use one light emitting diode ring or light emitting diode half-ring instead of several light emitting diodes and/or to arrange the light emitting diodes not in a circle but in any desired geometric manner. Furthermore, the at least one light emitting diode can be arranged together with the piezoelectronic system on a circuit board, and it is also possible to use other known illuminating means instead of light emitting diodes. Finally, the shapes of the actuator, housing and anchor plate can also be modified in any desired form independently of one another and may be, for example, oval or polygonal.

1. Electrical switching device having a housing (3, 303) intended for fastening on a support (2, 102), an actuator (8, 108) intended for pressing and illuminating means for indicating a switching state and/or visualization of the pressing surface of the actuator (8, 108), the housing (3, 103) having, on the front face, a disc-like cover plate (6, 106) facing the actuator (8, 108), and an electromechanical or electronic switching element (12, 112) for triggering a switching state being arranged on that side of the cover plate (6, 106) which is opposite the actuator (8, 108), characterized in that the cover plate (6, 106) is at least partly transparent and has, on the side facing away from the actuator (8, 108), at least one light emitting diode (16) intended for radiating light out of the cover plate (6, 106) and through the actuator (8, 108, 208).

2. Electrical switching device according to claim 1, characterized in that the housing (3, 103) has a piezoelectric switching element (12, 112).

3. Electrical switching device according to claim 1 or 2, characterized in that all parts carrying electrical voltages are sealed liquid-tight and/or gas-tight from the environment.

4. Switching device according to claim 2 or 3, characterized in that the actuator (8, 108) has the shape of a round cap having a cylindrical base (8a) facing the cover plate (6, 106) of the housing (3, 103) and can be displaced in the direction perpendicular to the contact surface (6b) of the cover plate (6, 106) against the force of a spring (9) between two end positions.

5. Switching device according to any of claims 2 to 4, characterized in that an annular groove (14) which has, in the base section, an annular light emitting diode holder (15), on which several, namely at least three, preferably at least six, light emitting diodes (16) distributed uniformly along the circumference of the annular groove (14) are fastened, is provided on the underside of the cover plate (6), and that the cover plate (6) is transparent at least in the region of the annular groove (14).

6. Switching device according to claim 5, characterized in that the annular light emitting diode holder (15) is fastened in the annular groove (14) by pressing in and/or snapping in and/or adhesive bonding.

7. Switching device according to claim 5 or 6, characterized in that the cover plate (6) consists of a transparent plastic, for example polymethyl methacrylate or polycarbonate, or of a mineral glass, at least in the region of the light emitting diodes (16).

8. Switching device according to any of claims 1 to 4, characterized in that the cover plate (106) consists of an opaque, resistant metallic material and has an annular gap (120) of several through-holes distributed regularly over a circle, in which annular gap or in which through-holes at least one light emitting diode (116) is arranged on an electrically insulating light emitting diode holder (115).

9. Switching device according claim 8 having an annular gap (120), characterized in that at least three, preferably at least six, light emitting diodes (116) distributed uniformly along the circumference of the annular gap (1) are arranged, that the annular light emitting diode holder (115) having the light emitting diodes (116) is fastened in the annular gap (120) by pressing in and/or snapping in and/or adhesive bonding, and that a closing means (117) is arranged in the annular gap (120) and serves for distributing the light produced during operation of the light emitting diodes (116) as far as possible uniformly over the entire mouth of the annular gap (120).

10. Switching device according to claim 9, characterized in that the closing means (117) consists of a transparent plastics ring made of acrylic glass or polycarbonate, or of a mineral glass.
